(19) United States
(12) Patent Application Publication
(10) Pub. No.: US 2004/0253031 A1
(43) Pub. Date: Dec. 16, 2004

(54) Paper handling apparatus and image forming system

(75) Inventor: Shigeru Okazaki, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA MINOLTA BUSINESS TECHNOLOGIES, INC.

(21) Appl. No.: 10/802,855

(22) Filed: Mar. 18, 2004

(30) Foreign Application Priority Data
Jun. 10, 2003 (JP) 2003-165068

(51) Int. Cl. G03G 15/00

(52) U.S. Cl. 399/381

(57) ABSTRACT

A paper handling apparatus having: at least one of a paper guide opening for receiving a paper carried from outside, and a paper discharge opening for discharging a paper outside; and a coupling section for coupling to other paper handling at a position approximately equal to that of the paper guide opening or the paper discharge opening in a vertical direction.

### BACKGROUND OF THE INVENTION

1. Field of the Invention

The present invention relates to a paper handling apparatus and an image forming system, and more particularly, to a paper handling apparatus which is capable of coupling, such as an image forming apparatus for forming an image on a paper, a paper feeding apparatus for feeding a paper to the image forming apparatus, and a post-processing apparatus for performing various post-processes like a folding process, a binding process or the like to a paper output from the image forming apparatus after an image is formed thereon, and an image forming system in which plural paper handling apparatuses are coupled with one another.

2. Description of the Related Art

An image forming apparatus for forming large volumes of images at high speed such as an electrophotographic system image forming apparatus is often used as an image forming system in which a paper feeding apparatus, a paper post-processing apparatus and so forth are coupled, not as a single piece of image forming apparatus. As a color image forming apparatus, there is a full color image forming apparatus (image forming system), in which plural image forming units (image forming apparatus) for forming an image with each color of yellow (Y), magenta (M), cyan (C), black (B) or the like are coupled.

In the case of forming an image forming system by coupling plural paper handling apparatuses for handling papers such as an image forming apparatus, a paper feeding apparatus, a paper post-processing apparatus or the like, an alignment among apparatuses to be coupled is an important factor for smoothly carrying papers among each paper handling apparatuses.

Therefore, there have been various approaches related to coupling among paper handling apparatuses.

The various paper handling apparatuses described above are individually mounted on the floor, however, the floor is not necessarily flat, and may have convexoconcaves or may be raked. Accordingly, the paper handling apparatus comprises feet called an adjuster foot for height adjustment among the paper handling apparatuses, enabling the paper handling apparatuses to perform height adjustment thereamong and correction for a horizontal misalignment of the floor.

For example, in JP-Tokukai-2000-81827A, there is proposed of coupling plural image forming units (image forming apparatus) by coupling sections for forming images with different colors, thereby correcting displacement among apparatuses to be coupled. In JP-Tokukai-2000-81827A, there is described to provide a coupling section adjacent to a paper feed opening and a paper discharge opening in paragraph 0023. However, FIG. 4 in JP-Tokukai-2000-81827A shows that the heights of coupling sections 23 and 24 differ significantly from those of a paper feed opening 21 and a paper discharge opening 22 taken as a whole apparatus, respectively. Thus, the positions of the coupling sections are away from the paper feed opening and the paper discharge opening in respect to the arranged height, respectively.

In FIG. 2 in JP-Tokukai-2000-81827A, for example, if the heights of the floor, base or the like of a process units 1Y and 1M are the same, the heights of the coupling section 24 of the process unit 1Y and the coupling section 23 of the process unit 1M become the same, enabling to couple them without putting any load to the both process units. Also, the heights of the paper discharge opening 22 of the process unit 1Y and the paper feed opening 23 of the process unit 1M become the same. However, if the heights of the floor, base or the like are different, the heights of the coupling section 24 of the process unit 1Y and the coupling section 23 of the process unit 1M differ. If they are coupled by force, distortion, twist or the like is generated between the both process units. Consequently, there would be a possibility that the heights of the paper discharge opening 22 of the process unit 1Y and the paper feed opening 23 of the process unit 1M differ, thereby causing a great effect on carrying papers.

A negative effect to carrying papers caused by a displacement among a coupling section, paper feed opening and the like will be explained by taking another paper handling apparatus as an example referring to FIG. 1.

FIGS. 1A and 1B are paper handling apparatuses coupled by earlier developed coupling sections.

FIG. 1A shows a paper handling apparatus M inclined to a front side or the right side in the figure, and FIG. 1B shows a paper handling apparatus inclined to a back side or the left side in the figure. The paper handling apparatus M is coupled to another paper handling apparatus with coupling sections CONU and CONL (for example, setscrews) positioned at upper and lower portions of the paper handling apparatus M, respectively, to be fixed one another.

A front panel FP of the paper handling apparatus. M is used as a standard for positioning for coupling the paper handling apparatus M to another paper handling apparatus. That is, one of coupling sections CONU and CONL of a paper handling apparatus is pressed onto the front panel FP of the paper handling apparatus M to perform the positioning.

Such coupling method may raise a problem as follows. When the paper handling apparatus M is inclined to the front side (right side) as shown in FIG. 1A, the lower coupling section CONL acts as a standard for positioning. Since both of the coupling sections CONU and CONL are used for coupling to prevent the paper handling apparatus M from being burdened, the upper coupling section CONU is shifted from the standard position by an inclination amount of the paper handling apparatus M when connecting apparatuses by using only the lower coupling section CONL. A carrying path PATH is shifted by a shift amount (L1*θ) in a horizontal direction, where θ is an angle of gradient of the paper handling apparatus M, and L1 is a height difference between the coupling section CONL and the carrying path PATH.

When the paper handling apparatus M is inclined to the back side as shown in FIG. 1B, the coupling section CONU at the upper portion is pressed to the front panel FP of another paper handling apparatus, so that the coupling section CONU at the upper part acts as a standard for positioning. Accordingly, when the paper handling apparatus M is inclined to the back side at an angle θ, the carrying path PATH is shifted by a shift amount (L2*θ) in the horizontal direction, where L2 is a height difference between the coupling section CONU and the carrying path PATH.

When carrying paths coupled in back and front direction are inclined with each other in up and down direction, there is relatively low possibility of affecting the carrying stability for carrying papers. Because up and down movements of papers are regulated by a guide forming carrying paths, an inclination between the carrying paths which causes only slight up and down movements of the papers has little affect on the carrying stability. Also, a height difference between the carrying paths of apparatuses to be coupled can be adjusted by adjuster feet.

However, a displacement in a width direction between the carrying paths coupled in back and forth directions would cause great affect on the carrying stability. That is, the carrying paths do not comprise any member to regulate papers to move in the width direction for carrying papers with different widths. Thus, a shift generated in the width direction would be widened as papers are carried.

In an image forming process, when a shift is generated in the width direction, an image position shifts, causing a degradation of an image quality.

Generally, a double-side image formation is performed by flipping a paper to form an image on the other side after forming an image on one side. However, there is a problem that the double-side image formation is inefficient in comparison with a single-side image formation.

### SUMMERY OF THE INVENTION

An object of the present invention is to solve the above described problem with the earlier developed coupling sections, and to provide an image forming system having a paper carrying mechanism with high stability and reliability, and a paper handling apparatus constructing the image forming system in the image forming system formed by coupling plural paper handling apparatuses.

Another object of the present invention is to provide an image forming system for efficiently performing a double-side image formation.

In order to attain the above described object, in accordance with a first aspect of the present invention, the paper handling apparatus comprising:

at least one of a paper guide opening for receiving a paper carried from outside, and a paper discharge opening for discharging a paper outside; and

a coupling section for coupling to other paper handling at a position approximately equal to that of the paper guide opening or the paper discharge opening in a vertical direction.

Preferably, in the paper handling apparatus of the first aspect of the present invention, the coupling section is arranged at two positions approximately symmetric with respect to a center of a carrying path in a paper carrying direction.

Preferably, in the paper handling apparatus of the first aspect of the present invention, the coupling section is arranged at a position within a range of ±60 mm from a position of the paper guide opening or the paper discharge opening in a vertical direction.

In the paper handling apparatus of the first aspect of the present invention, the paper handling apparatus may comprise both of the paper guide opening and the paper discharge opening, which may be arranged at an approximately same position in a vertical direction.

Preferably, in the paper handling apparatus of the first aspect of the present invention, the paper handling apparatus comprises any one of an image forming apparatus for forming an image, a paper feeding apparatus for feeding the paper to the image forming apparatus, and a paper post-processing apparatus for performing a post-process to the paper which was discharged from the image forming apparatus.

In accordance with a second aspect of the present invention, the image forming system comprises:

a plurality of paper handling apparatuses,

wherein each of the paper handling apparatuses comprises at least one of a paper guide opening for receiving a paper carried from outside, and a paper discharge opening for discharging a paper outside, and a coupling section for coupling to other paper handling apparatus at a position approximately equal to that of the paper guide opening or the paper discharge opening in a vertical direction; and the plurality of paper handling apparatuses are coupled by the coupling section.

Preferably, in the image forming system of the second aspect of the present invention, the coupling section is arranged at two positions approximately symmetric with respect a center of a carrying path in a paper carrying direction.

Preferably, in the image forming system of the second aspect of the present invention, the coupling section is arranged at a position within a range of ±60 mm from a position of the paper guide opening or the paper discharge opening in a vertical direction.

In the image forming system of the second aspect of the present invention, at least one of the plurality of paper handling apparatuses may comprise both of the paper guide opening and the paper discharge opening, which may be arranged at an approximately same position in a vertical direction.

Preferably, in the image forming system of the second aspect of the present invention, each of the plurality of paper handling apparatuses comprises any one of an image forming apparatus for forming an image, a paper feeding apparatus for feeding the paper to the image forming apparatus, and a paper post-processing apparatus for performing a post-process to the paper which was discharged from the image forming apparatus.

In the image forming system of the second aspect of the present invention, any one of the plurality of paper handling apparatuses may comprise an image forming apparatus comprising a displacement detection section for detecting a displacement of a paper in a direction perpendicular to a paper carrying direction, and a correction section for correcting a displacement of the paper according to a detected result by the displacement detection section.

In the image forming system of the second aspect of the present invention, the image forming system may comprises an image forming apparatus on an upstream side for forming an image on a first side of the paper and, an image forming apparatus on a downstream side for forming an image on a second surface of the paper.

### BRIEF DESCRIPTION OF THE DRAWINGS

The present invention will become more fully understood from the detailed description given hereinafter and the accompanying drawings which are given by way of illustration only, and thus are not intended as a definition of the limits of the present invention, and wherein;

FIGS. 1A and 1B are views showing paper handling apparatuses coupled by earlier developed coupling sections;

FIG. 2 is an overall view of an image forming system according to an embodiment of the present invention;

FIG. 3 is a view showing a paper handling apparatus according to the embodiment of the present invention;

FIG. 4 is a view showing an image forming apparatus according to the embodiment of the present invention;

FIG. 5 is a view showing a paper post-processing apparatus according to the embodiment of the present invention;

FIGS. 6A-6C are views showing folding operations;

FIGS. 7A-7D are views showing various folding ways;

FIG. 8 is a view showing the post-processing apparatus according to the embodiment of the present invention;

FIG. 9 is a side view of a coupling portion;

FIGS. 10A-10B are views showing paper handling apparatuses coupled by coupling sections of the embodiment in the present invention;

FIG. 11 is an exploded perspective view showing the coupling portion;

FIG. 12 is a sectional view showing the coupling portion as seen from above;

FIG. 13 is a sectional view showing the coupling portion as seen from above;

FIG. 14 is a sectional view showing the coupling portion as seen from above;

FIG. 15 is a view showing a displacement detection section; and

FIG. 16 is a view showing an image forming apparatus according to the embodiment in the present invention.

### DETAILED DESCRIPTION OF THE PREFERRED EMBODIMENTS

<Image Forming System>

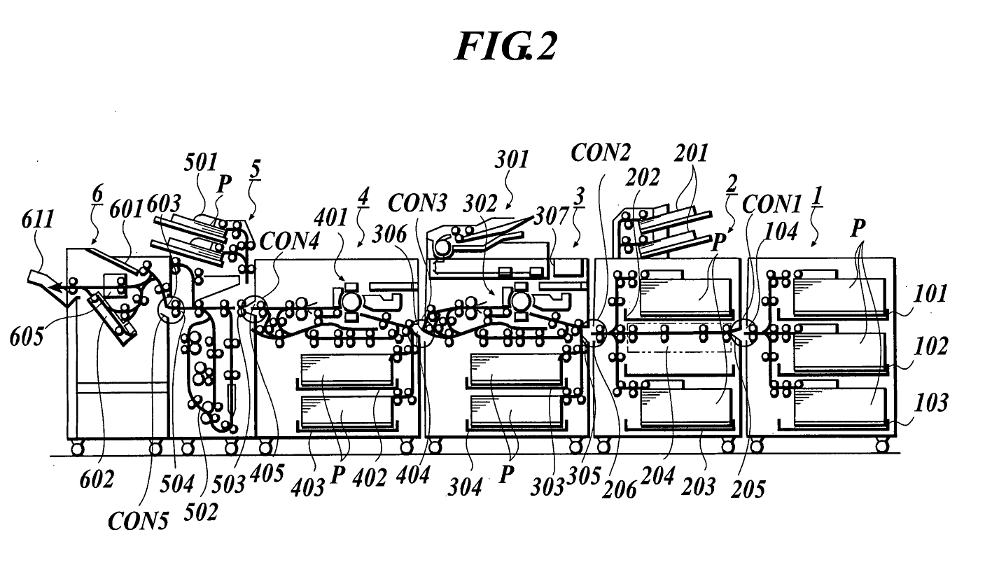

FIG. 2 is an overall view showing an image forming system according to the embodiment in the present invention.

This image forming system comprises two paper feeding apparatuses 1 and 2, two image forming apparatuses 3 and 4, and two paper post-processing apparatuses 5 and 6.

The paper feeding apparatus 1 comprises three paper storing sections 101, 102 and 103 for storing papers P. The paper feeding apparatus 2 comprises two paper storing sections 202 and 203, and a manual feeder 201, for storing papers P. The paper feeding apparatus 2 is provided with an intermediate carrying section 204 in a space for disposing the paper storing sections, for carrying the papers P from the paper feeding apparatus 1 to the image forming apparatus 3. The image forming apparatus 3 comprises an image scanning section 301, an image forming section 302, paper storing sections 303 and 304 for storing papers P, and a communication interface 307. The image forming apparatus 4 comprises an image forming apparatus 401, and paper storing sections 402 and 403 for storing papers P.

The paper post-processing apparatus 5 comprises a paper feeding section 501 and a folding section 502. The paper post-processing apparatus 6 comprises a fixed paper catch tray 601, a binding processing section 602, a liftable paper catch tray 611, and a shifting processing section 605.

Papers P stored in the paper feeding apparatus 1 are discharged from a paper discharge opening 104 to be guided to a paper guide opening 205 of the paper feeding apparatus 2. Then, the papers P are discharged from a paper discharge opening 206 to be guided to a paper guide opening 305 of the image forming apparatus 3.

Papers P stored in the paper feeding apparatus 2 are discharged from the paper discharge opening 206 to be guided to the paper guide opening 305 of the image forming apparatus 3.

The image forming apparatuses 3 and 4 perform an image formation to papers. That is, the image forming apparatus 3 performs an image formation to the papers P stored in the paper feeding apparatuses 1 and 2 and the image forming apparatus 3, and the image forming apparatus 4 performs an image formation to the papers P stored in the paper feeding apparatuses 1 and 2 and the image forming apparatuses 3 and 4.

The image forming apparatuses 3 and 4 are used as a master machine and a slave machine, respectively. That is, the image forming apparatus 3 comprises the image scanning section 301 for generating image data by scanning an original, and the communication interface 307 for receiving image data from outside.

When performing large volumes of printings, image data can be divided to be stored in the image forming apparatuses 3 and 4 individually for forming an image, or when a double-side image formation is performed, the image forming apparatus 3 can perform an image formation on one side and the image forming apparatus 4 can perform an image formation on the other side. Accordingly, the image forming apparatuses 3 and 4 can be functionally divided with each other as described above, so that large volumes of image formation can be performed with high efficiency.

The papers P processed in the image forming apparatus 4 are discharged from a paper discharge opening 405 to be guided to a paper guide opening 503 in the paper post-processing apparatus 5.

Papers P that are not given any post-process such as stapling, shifting or the like are discharged onto the fixed paper catch tray 601. When any of these post-processes is performed, the papers P are discharged onto the liftable catch tray 611 after the post-processes.

The paper feeding apparatuses 1 and 2 are coupled with each other by a coupling section CON1, and the paper feeding apparatus 2 and the image forming apparatus 3 are coupled with each other by a coupling section CON 2. The image forming apparatuses 3 and 4 are coupled with each other by a coupling section CON3, and the image forming apparatus 4 and the paper post-processing apparatus 5 are coupled with each other by a coupling section CON 4. The paper post-processing apparatuses 5 and 6 are coupled with each other by a coupling section CON 5.

It is preferable that a paper guide opening and a paper discharge opening of a paper handling apparatus are located at the same position in a vertical direction, such as, for example as shown in FIG. 2, the paper guide opening 205 and the paper discharge opening 206 of the paper feeding apparatus 2, the paper guide opening 305 and the paper discharge opening 306 of the image forming apparatus 3, and the paper guide opening 503 and the paper discharge opening 504 of the paper post-processing apparatus 5, thereby increasing the freedom of combination of each paper handling apparatus.

Specifically, for example, the paper feeding apparatus 2 is mounted on the right side of the image forming apparatus 2 in FIG. 2, the paper feeding apparatus 2 may be mounted on the left side of the image forming apparatus 2. That is, various combinations of paper handling apparatuses can be employed according to a user's demand.

<Paper Feeding Apparatus>

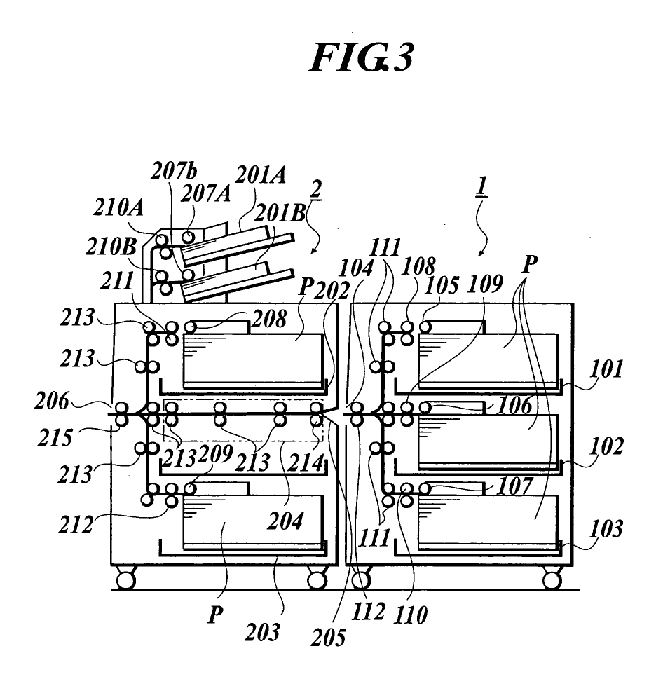

The paper feeding apparatuses 1 and 2 are explained referring to FIG. 3. FIG. 3 shows the paper feeding apparatus according to the embodiment in the present invention.

The paper feeding apparatus 1 comprises three paper storing sections 101, 102 and 103, which are provided with a feeding roller 105 and a separation roller 108, a feeding roller 106 and a separation roller 109, and a feeding roller 107 and a separation roller 110, respectively.

For example, papers P stored in the paper storing section 101 is fed by the feeding roller 105 to be carried separately one by one by the separation roller 108. A paper P separated is carried by intermediate carrying rollers 111 to be discharged from the paper guide opening 104 by the discharge roller 112 to the paper feeding apparatus 2. Papers P stored in the paper storing sections 102 sections 102 and 103 are also separately carried one by one by the feeding roller and the separation roller corresponding each of them. A paper separated is carried by the intermediate carrying rollers 111 to be discharged by the discharge roller 112.

The paper feeding apparatus 2 comprises two manual paper feeding sections 201A and 201B and two paper storing sections 202 and 203.

The paper feeding apparatus 2 comprises a function of receiving the paper guided from the paper feeding apparatus 1 to the paper guide opening 205, by using a guide roller 214, and carrying the paper P to feed to the image forming apparatus 3, a function of feeding a paper P from the manual paper feeding sections 201A and 201B, and a function of feeding a paper P from the paper storing sections 202 and 203.

The paper P received from the paper feeding apparatus 1 is carried by a guided roller 214 and intermediate carrying rollers 213 making up the intermediate carrying section 204 to be discharged from the paper discharge opening 206 by a discharge roller 215.

Papers P placed on the manual paper feeding section 201A are fed by a feeding roller 207A, and are carried separately one by one by a separation roller 210A. A paper P separated is carried by the intermediate carrying rollers 213 to be discharged by the discharge roller 215. Thereafter, the paper is guided to the image forming apparatus 3. Pares P placed on the manual paper feeding section 201B are also carried in the same manner to be discharged by the discharge roller 215.

Papers P stored in the paper storing section 202 are fed by a feeding roller 208, and are carried separately one by one by a separation roller 211. A paper P separated is carried by the intermediate carrying rollers 213 to be discharged by the discharge roller 215.

In the same manner, papers P stored in the paper storing section 203 are also carried separately one by one by a feeding roller 209 and a separation roller 212. A paper P separated is carried by the intermediate carrying rollers 213 to be discharged by the discharge roller 215.

<Image Forming Apparatus>

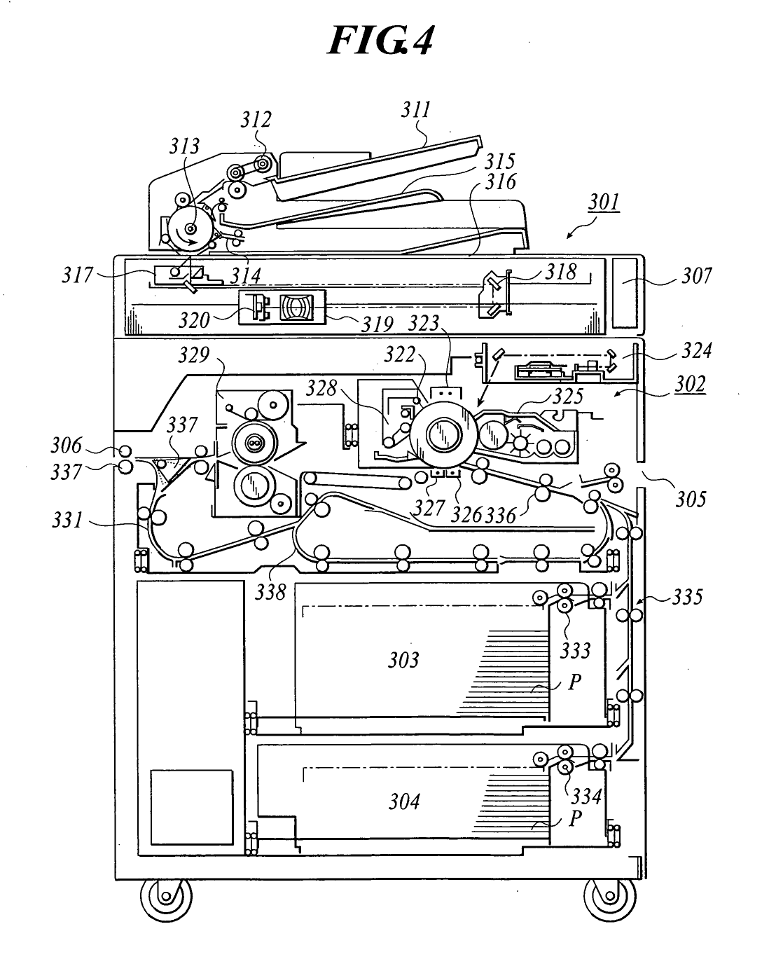

The image forming apparatuses 3 and 4 are explained referring to FIG. 4. FIG. 4 is a view showing the image forming apparatus according to the embodiment of the present invention.

The image forming apparatus 3 comprises the image reading section 301, the image forming section 302, and the paper storing sections 303 and 304.

The image reading section 301 comprises an original carrying device and an optical reader. The original carrying device comprises an original feeding tray 311 for placing originals to read, an original feeding unit 312 for feeding the originals one by one, a platen roller 313 for carrying the originals at a position for reading the originals, a reversing and carrying portion 314 for reversing the original, and an original discharge tray 315 on which the originals which have been read are discharged.

The originals placed on the original feeding tray 311 are carried separately one by one to go around the platen roller 313, and an image reading is performed at a reading position under the platen roller 313.

For a single-side reading, the original read on one side is discharged onto the discharge tray 315. For a double-side reading, the original read on one side is reversed by the reversing and carrying portion 314, and thereafter, fed back to the platen roller 313 to perform image reading on the other side. Then, the original is discharged.

The image reading is performed to originals carried by the original carrying device and also, to originals placed on a platen glass 316.

The optical reader comprises a scanning unit 317 having a lump for illuminating an original and a mirror, an imaging lens 319, and an imaging element 320 comprising a line CCD.

For a mode of reading an original that is being carried, a reading is carried out with the optical elements of the optical reader placed at fixed locations.

For a mode of reading an original on the platen glass 316, the scanning units 317 and the 318 are moved along the platen glass 316 for reading.

The image forming section 302 is of forming an image on a paper P by an electrophotographic method, comprising a photosensitive body 322, a charging device 323, an exposure device 324, a developing device 325, a transferring device 325, a separating device 327, a cleaning device 328, and a fixing device 329. A toner image is formed on the photosensitive body 322 through the steps of charging, exposure and developing. Then, the toner image is transferred to a paper P by the transferring device 326 to be fixed on the paper P by the fixing device 329.

The image forming section 302 has a double-side image forming function. For the double-side image formation, a paper P, on one side of which an image was formed and then subjected to an image fixing process, is guided downward by a switch guide 337, and then carried to a branch path 331 for forming an image on the other side. The paper P is reversed in a reversing and carrying section 338, and is fed to a resist roller 336 to be transferred to a transferring position, thereby forming an image on the other side.

The paper storing sections 303 and 304 are provided with feeding units 333 and 334, respectively, for carrying papers P separately one by one to be fed to the resist roller 336 through a feeding path 335.

Papers P fed from the paper feeding apparatus 1 or 2, or papers P fed from the paper storing section 303 or 304 are subjected to the above explained processes to form an image on one side or both sides of the papers P. The papers P on which an image is formed are discharged from the discharge opening 306 to the image forming apparatus 4 by the discharge roller 337.

The image forming apparatus 4 has substantially the same configuration as the image forming apparatus 3 with the exception that the image forming apparatus 4 does not have the image reading section 301 and the communication interface 307.

The image forming apparatuses 3 and 4 are used as a master machine and a slave machine, respectively. That is, image data is generated in the image scanning section 301 or the communication interface 307 of the image forming apparatus 3, and the image forming section 302 of the image forming apparatus 3 and the image forming apparatus 4 form an image on the basis of the image data from the image scanning section 301 or the communication interface 307.

For the double-side image formation, the image forming apparatus 3 performs an image formation on one of the sides of a paper, and the image forming apparatus 4 performs an image formation on the other side thereof, thereby the image formation on both sides can be performed at high speed.

That is, after forming an image on the first side of a paper P by the image forming apparatus 3, the paper is carried to the branch path 331 to be reversed. Thereafter, the paper P is discharged from the paper discharge opening 306. Therefore, the image forming apparatus 4 can form an image on the reversed paper P.

In the image forming system shown in the figure, when a double-side image formation is set, an operation mode in which a paper is reversed after forming an image on one side by the image forming apparatus 3 to form an image on the reversed paper by the image forming apparatus 4 is automatically selected.

<Paper Post-Processing Apparatus>

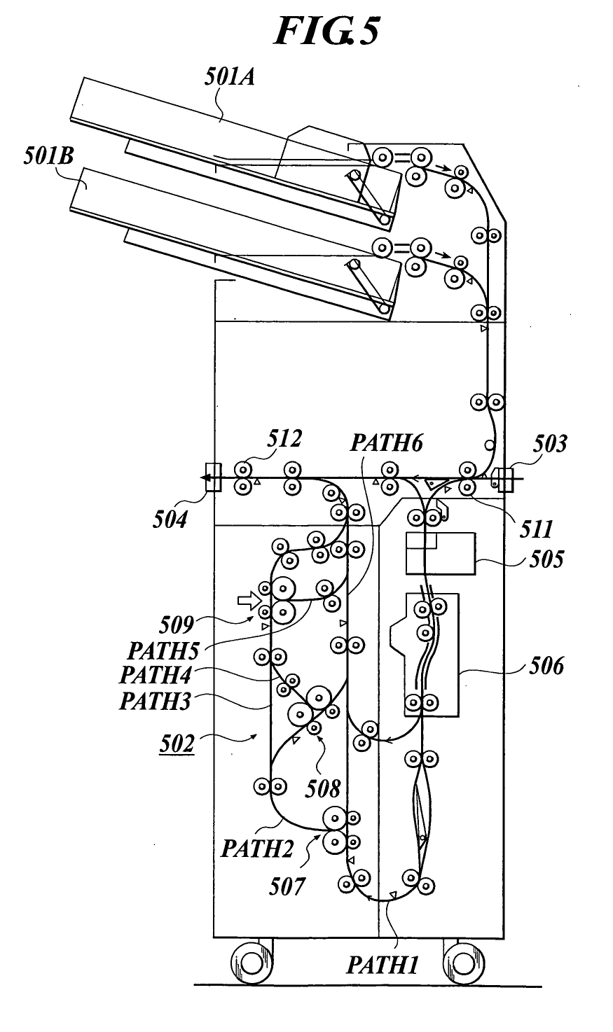

FIG. 5 shows the paper post-processing apparatus 5 according to the present invention.

The paper post-processing apparatus 5 is for performing a punching process and folding process on papers P received from the image forming apparatus 4. The above processes are performed after papers P from an additional paper feeding section for feeding papers P for cover or divider are added to the papers P from the image forming apparatus 4.

A paper guide opening 503 is mounted such that the position and the height thereof correspond to those of the paper discharge opening 405 in the image forming apparatus 4. A guide roller 511 mounted at the paper guide opening 503 receives a paper P discharged from the image forming apparatus 4 to carry.

Papers P fed from paper feeding trays 501A and 501B mounted at a top portion of the paper post-processing apparatus 5 are guided to the guide roller 511.

Papers P for cover, back cover and divider are put on the paper feeding trays 501A and 501B of the additional paper feeding section are carried therefrom separately one by one.

A paper P carried by the guide roller 511 moves straight to be discharged by a discharge roller 512, or moves downward and passes through a punching section 505, an alignment section 506 and the folding section 502 to be discharged by the discharge roller 512.

The punching section 505 is a unit for punching holes in an end portion of a paper P, and the alignment section is a unit for aligning a paper P ahead of the punching process.

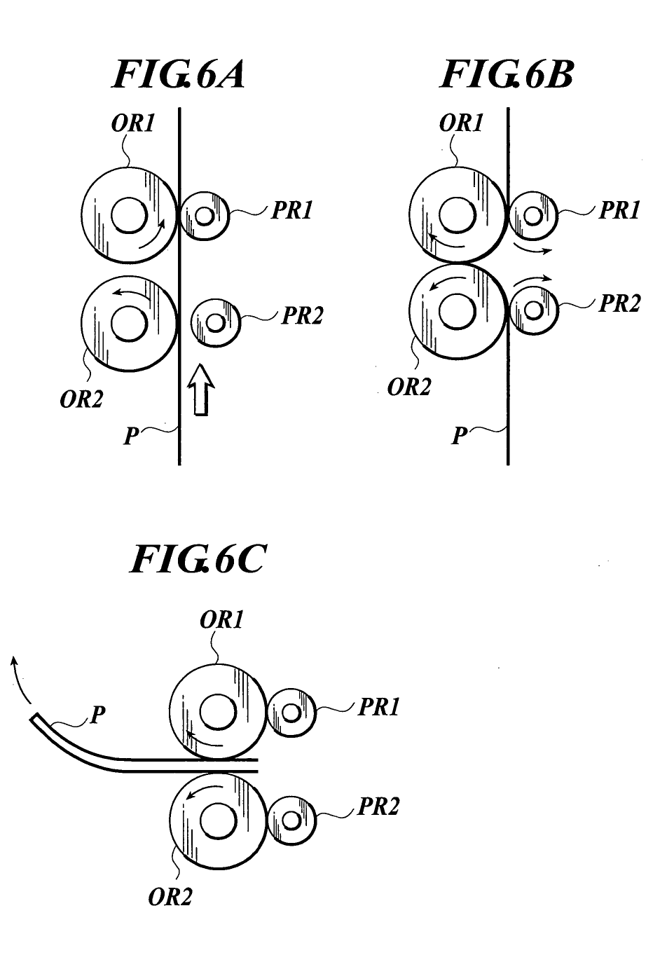

The folding section 502 comprises three folding units 507, 508 and 509, each of which has folding rollers OR1 and OR2 as shown in FIGS. 6A-6C. The folding rollers OR1 and OR2 are brought into contact with driven rollers PR1 and PR2, respectively.

In the first step, a paper P is guided between the folding roller OR1 and the driven roller PR1 by the rotation of the folding roller OR1 (FIG. 6A).

In the second step, as shown in FIG. 6B, the paper P is pressed between the folding rollers OR1 and OR2 by rotating the folding roller OR1 in clockwise direction and the folding roller OR2 in anticlockwise direction. As shown in the figure, the paper P is folded in the second step.

In the third step, as shown in FIG. 6C, the folding rollers OR1 and OR2 continue to rotate in clockwise and anticlockwise directions, respectively, to send the folded paper P out of the folding unit.

As shown in FIG. 5, the paper post-processing apparatus 5 comprises carrying paths PATH1-PATH6 for performing various folding processes by appropriately using each of the carrying paths.

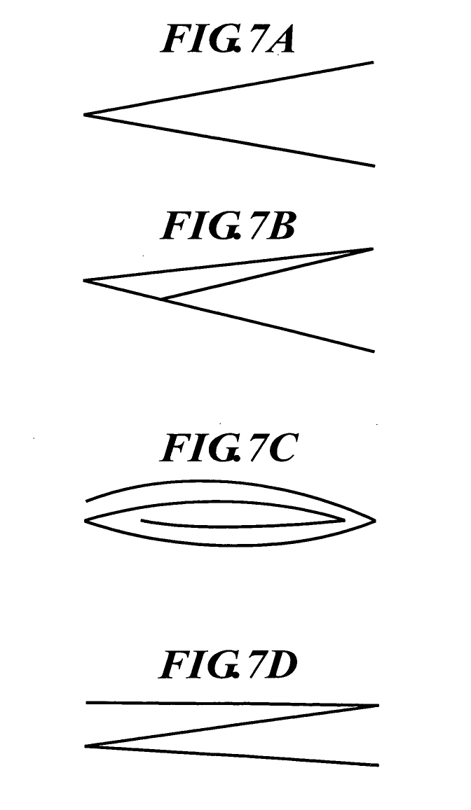

For example, a two-folding process shown in FIG. 7A is performed as follows. A paper P is carried to the folding unit 507 from the carrying path PATH1, and then folded. The folded paper P is carried to the carrying path PATH6 through the carrying path PATH2 to be discharged. A three-folding process shown in FIG. 7B is performed as follows. The paper P folded in half in the folding unit 507 is carried to the folding unit 508 from the carrying path PATH2, and then folded. The folded paper P is carried to the carrying path PATH3 through the carrying path PATH4 to be discharged. Further, a four-folding process shown in FIG. 7C is performed by carrying the paper P folded in three in the folding unit 508 to the folding unit 509 to be folded. A Z-folding process shown in FIG. 7D is performed by carrying the paper P folded in the folding unit 507 to the folding unit 509 from the carrying path PATH3 to be folded.

A paper P processed in the paper post-processing apparatus 5 is discharged by the discharge roller 512 from the paper discharge opening 504, and is guided to the paper post-processing apparatus 6 from a paper guide opening 603 thereof.

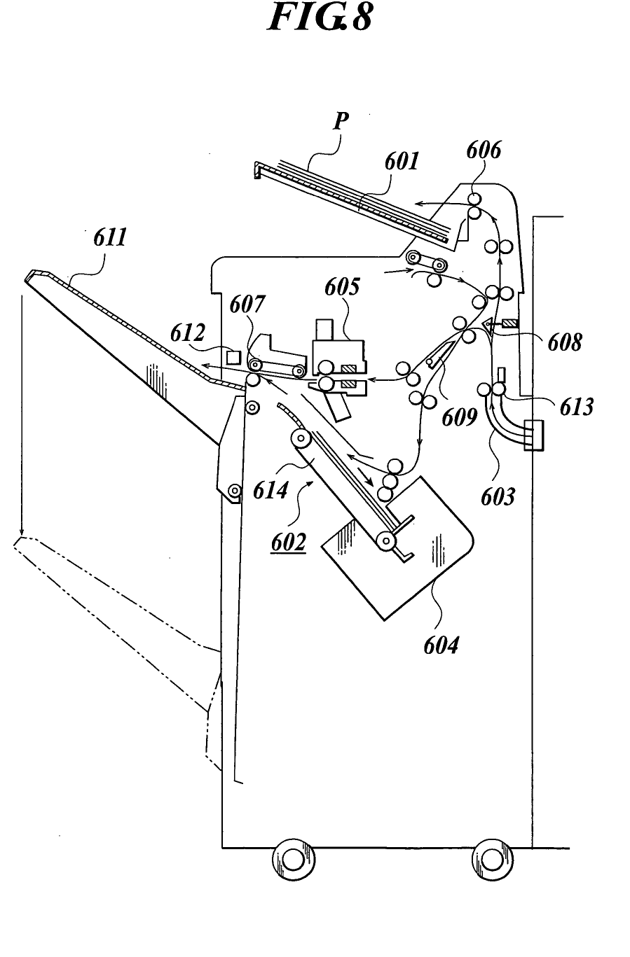

FIG. 8 shows the paper post-processing apparatus 6.

The paper post-processing apparatus 6 receives papers discharged from the paper post-processing apparatus 5 to perform a binding process or a shifting process.

The paper P discharged from the paper post-processing apparatus 5 is guided to a guide roller 613 from the paper guide opening 603 to be carried to the binding processing section 602 or the shifting processing section 605.

The binding processing section 602 is, as is generally known, for stacking plural papers P on a slanting stacker 614, and then performing the binding process in a binding processing unit 604 by using binding needles to the stacked papers P.

The shifting processing section 605, as is generally known, for discharging papers P on the liftable catch tray 611 while switching a discharge position by predetermined amount of papers.

The paper P guided to the post-processing apparatus 6 is guided upward in FIG. 8 by a switch guide 608 to be discharged by a discharge roller 606 onto the fixed paper catch tray 601, or is guided to the left in FIG. 8.

The paper P guided to the left is guided downward or to the left in FIG. 8 by a switch guide 609.

Papers P guided downward are bound in the binding processing section 602 to be discharged by a discharge roller 607 onto the liftable catch tray 611.

Papers P guided to the left are given the shifting process in the shifting processing section 605 to be discharged by the discharge roller 607 onto the liftable catch tray 611.

The liftable catch tray 611 moves up and down. When a paper sensor 612 detects a paper P, the liftable catch tray 611 moves downward, enabling a lot of papers P to be stacked thereon.

<Coupling Section>

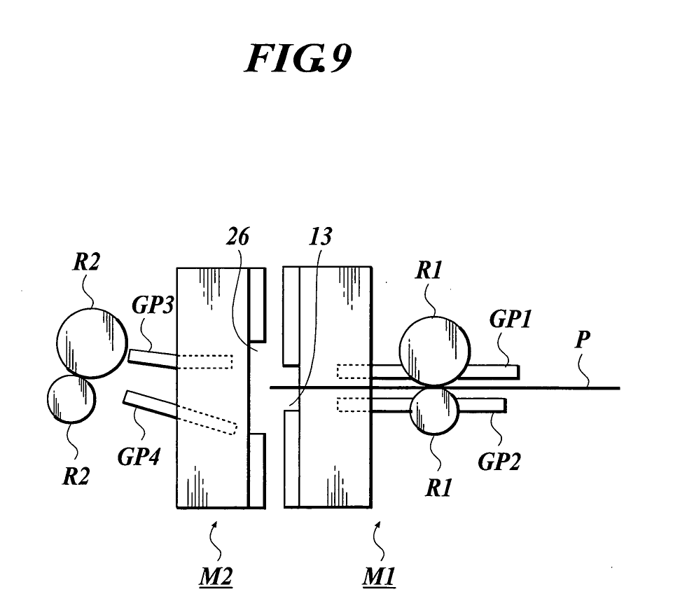

Coupling sections CON1-CON5 shown in FIG. 2 have the same configuration. The coupling sections are explained referring to FIGS. 9-14. In FIGS. 9-14, the paper feeding apparatuses 1 and 2, the image forming apparatuses 3 and 4, and the paper post-processing apparatuses 5 and 6 are shown as a paper handling apparatus M1 or M2. M1 denotes a paper handling apparatus on the upstream side, and M2 denotes a paper handling apparatus on the downstream side.

FIG. 9 is a side view of the coupling portion. In FIG. 9, a paper is carried by a discharge roller R1, and is guided by guides GP1 and GP2 to be discharged from a paper discharge opening 13 out of the paper handling apparatus M1. The paper discharged from the paper handling apparatus M1 is guided into the paper handling apparatus M2 from a paper guide opening 26 thereof. Thereafter, the paper is guided by guides GP3 and GP4 to be carried by a carrying roller R2.

The paper guide opening 26 has a width wider than that of the paper discharge opening 13. The upper guide GP3 and the lower guide GP4 of the paper handling apparatus M2 are arranged to have a wide-open shape corresponding to the paper guide opening 26 having a wide width. It is preferable to dispose the paper discharge opening 13 and the paper guide opening 26 at the same height. In this embodiment, the same height denotes that the height at the edge of the lower end of the paper guide opening 13 is equal to or slightly higher than that of the paper guide opening 26, and the height at the edge of the upper end of the paper guide opening 13 is equal to or slightly lower than that of the paper guide opening 26.

This paper transferring configuration between the paper handling apparatuses M1 and M2 is successful in transferring a paper smoothly.

The coupling section is arranged at the height approximately equal to that of the paper discharge opening 13 and the paper guide opening 26.

The height of the paper discharge opening 13 and the paper guide opening 26 is defined by taking an intermediate value between a highest value and a lowest value that are acquired by measuring a height at a paper when passing through the paper discharge opening 13 or the paper guide opening 26.

By making the height of the coupling section approximately equal to that of the carrying path, a carrying stability is less affected by inclination of the paper handling apparatus M1 or M2 caused by inclination or a convexoconcave of a floor.

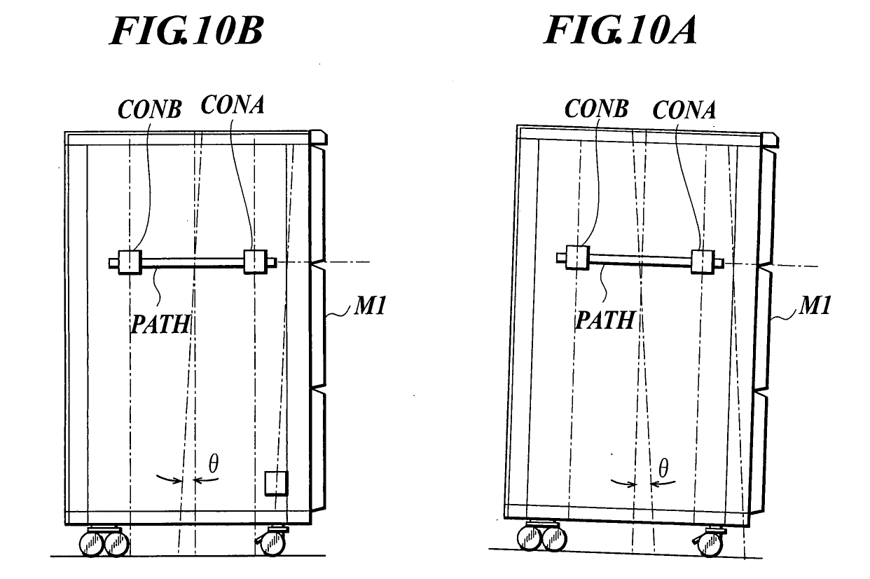

Effect on carrying paper which is caused by inclination of the paper handling apparatus M1 or M2 will be explained referring to FIGS. 10A and 10B. FIGS. 10A and 10B are views for explaining a displacement of the carrying path by inclination of the paper handling apparatus to be mounted.

An explanation will be given by comparing the coupling sections of the present invention and the coupling sections of the earlier developed technique by which the paper handling apparatuses M1 and M2 are coupled at upper and lower two points. FIGS. 10A and 10B show only the paper handling apparatus M1, however, an inclination angle θ of the paper handling apparatus M1 in FIGS. 10A and 10B is to the paper handling apparatus M2 that is not shown.

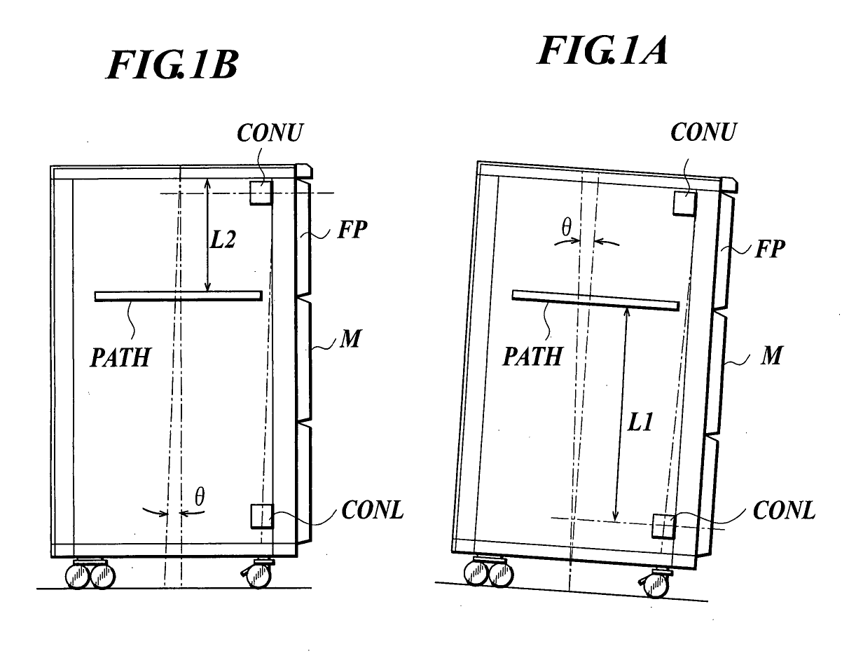

As explained above referring to FIG. 1, in the case that the height of the carrying path is not equal to that of the coupling section, a displacement between carrying paths is generated, thereby causing instability of carrying or a misalignment of an image.

In this invention, coupling sections CONA and CONB between the paper handling apparatuses are mounted at the height equal to that of the carrying path PATH. The coupling section CONA and CONB are located approximately symmetric with regard to the centerline of a carrying path PATH. A positioning between the paper handling apparatuses are performed by using the coupling sections CONA and CONB as a standard.

Use of such the coupling sections CONA and CONB would not cause a displacement of the carrying path PATH in a horizontal direction, because a rotation center of the inclination angle θ corresponds to the carrying path PATH.

Accordingly, the present invention can extremely reduce a possibility to cause an instability of carrying even if there is a slight inclination between the paper handling apparatuses to be coupled.

There may be a slight gap between the heights of the carrying path PATH and the coupling section. When mounting the coupling section at the height within the range of ±60 mm from the height of the carrying path, a displacement between the carrying paths would be extremely small. Thus, the object of the present invention can be accomplished. When coupling a plurality of paper handling apparatuses, it is preferable that the total value of height difference among the apparatuses is within ±60 mm.

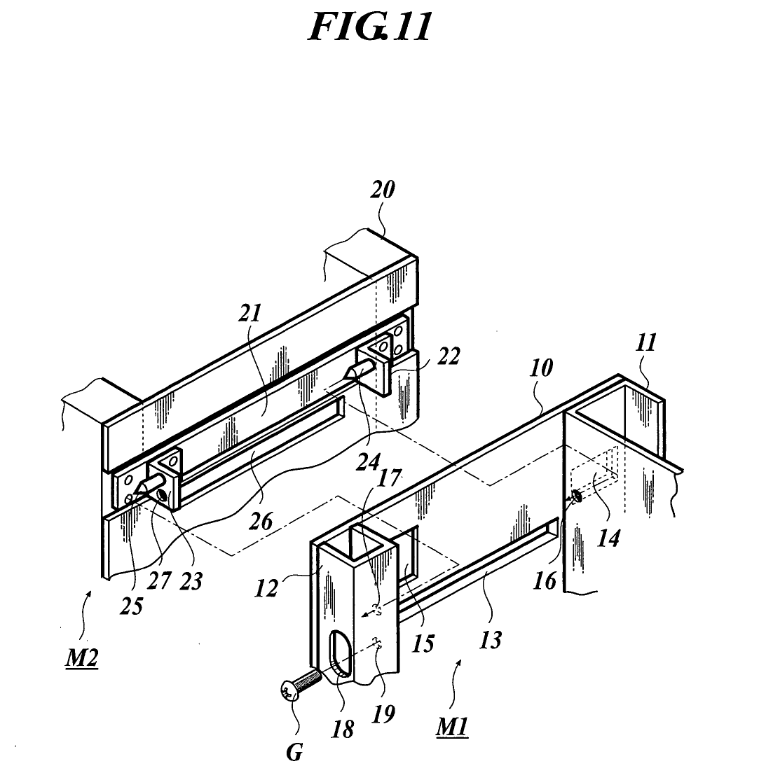

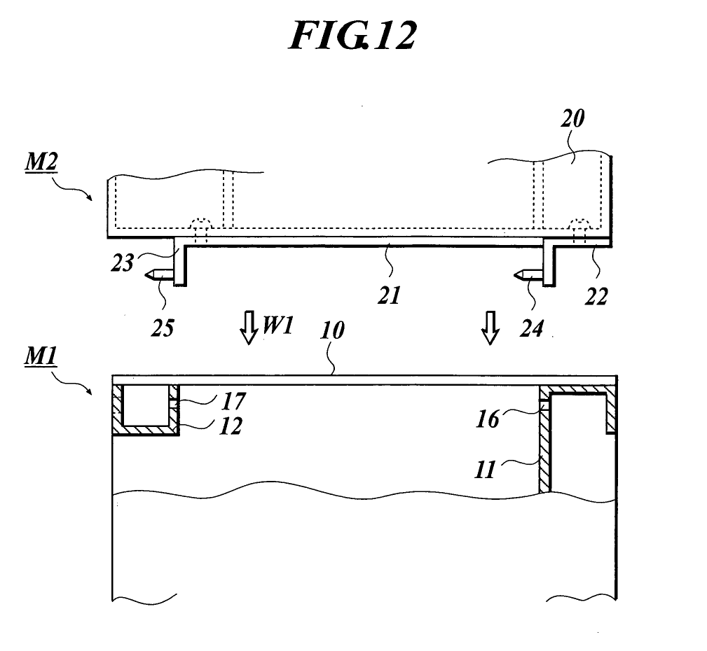

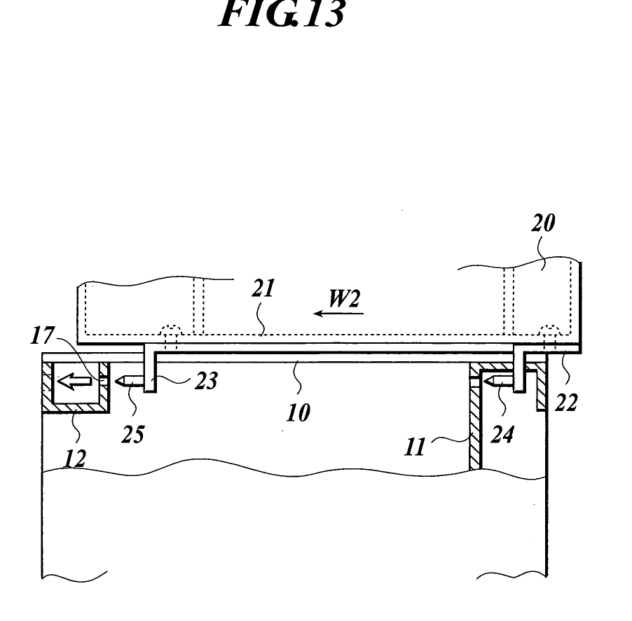

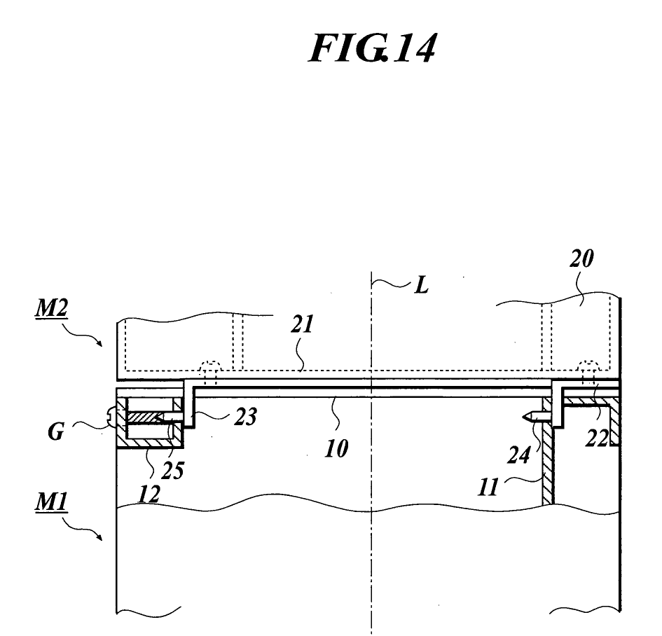

FIG. 11 is an exploded perspective view of the coupling portion, and FIGS. 12 to 14 are cross sectional views of the coupling portion seen from above. FIGS. 12 and 13 are the cross sectional views of the coupling portion in a phase before being coupled, and FIG. 14 is the cross sectional view of the coupling portion after being coupled.

The paper handling apparatus M is provided with upstanding fixing members 11 and 12 making up the coupling section, at both ends of a frame body 10. The frame body 10 comprises the paper discharge opening 13 to discharge a paper therefrom. The fixing members 11 and 12, as shown in FIG. 14, are arranged at approximately equal spaces from the center of the carrying path, that is, a centerline L in a width direction of the carrying path.

The frame body 10 is provided with rectangular holes 14 and 15. Further, the fixing member 11 is provided wit a circular hole 16, and the fixing member 12 is provided with a circular hole 17, a slotted hole 18 and a circular hole 19.

A supporting plate 21 is fixed on a frame body 20 of the paper handling apparatus M2, and L shaped fixing members 22 and 23 are fixed at both end portions of the supporting plate 21. The frame body 20 is provided with a paper guide opening 26 for guiding a paper to the paper handling apparatus M2 therefrom.

Pin 24 and 25 making up the coupling section are fixed on the fixing member 22 and 23, respectively. The fixing member 23 is further provided with a screw hole 27.

The paper handling apparatus M2 is moved in a direction shown by an arrow W1 in FIG. 12 to bring it close to the paper handling apparatus M1. When the frame body 10 is in contact with the frame body 20 as shown in FIG. 13, the paper handling apparatus M2 is moved in an direction shown by an arrow W2. Thus, a front side surface (right end surface in the figure) and a back side (left end surface in figure) of the frame body 11 correspond to those of the frame body 12, respectively, enabling the paper handling apparatuses M1 and M2 to be positioned at a proper position in the carrying path width direction.

As the paper handling apparatus M2 is moved closer to the paper handling apparatus M1, the fixing members 22 and 23 are engaged with the rectangular holes 14 and 15, respectively.

By positioning the paper handling apparatuses M1 and M2 at the proper position, the pins 24 and 25 are engaged with the circular holes 16 and 17, respectively, in the state of being consistent with each other.

The coupling section constructed by such the pin and hole coupling can position the paper handling apparatuses M1 and M2 at the proper position with high accuracy in up-down and right-left directions.

After positioning the paper handling apparatuses M1 and M2, a screw G making up the fixing section is inserted into the slotted hole 18 and the circular hole 19 to be tightened into a screw hole 27, thereby mutually fixing the paper handling apparatuses M1 and the paper handling apparatus M2.

As explained above, in the case of coupling plural paper handling apparatuses according to the present invention, a displacement of the paper carrying path caused by an inclination or a convexoconcave of a floor can extremely be prevented.

Further, the image forming apparatus may comprise the function to correct a displacement of a paper. Accordingly, in case that there is some displacement between carrying paths of paper handling apparatuses at the most upstream side and the most downstream side generated as a result of an accumulation of individual slight displacement of plural paper handling apparatuses coupled, a displacement would not be generated at a position where an image is formed, enabling to obtain an image with high quality.

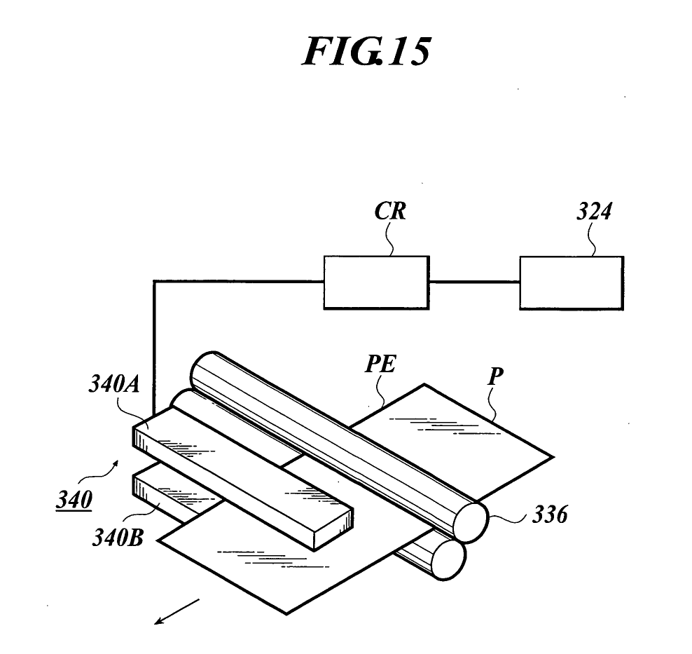

FIG. 15 shows an example of an image forming apparatus for performing a correction of a paper displacement.

A displacement sensor 340 is disposed just downstream of a resist roller 336. The displacement sensor 340 comprises a line sensor 340A and an LED array which are long in the width direction of the carrying path, for detecting an edge PE of a paper to be carried. A control section CR as a correction section for correcting a displacement of a paper controls an exposure scanning by an exposure device 324 (shown in FIG. 4) according to a detection signal detected by the displacement sensor 340. The control of the exposure scanning indicates a control of a scanning start position in a main scanning direction corresponding to a displacement to form an image at an image position moved in the main scanning direction.

Such a correction corresponding to a displacement of a paper may be used in the technique described, for example, in a specification in Japanese Patent No. 2550558.

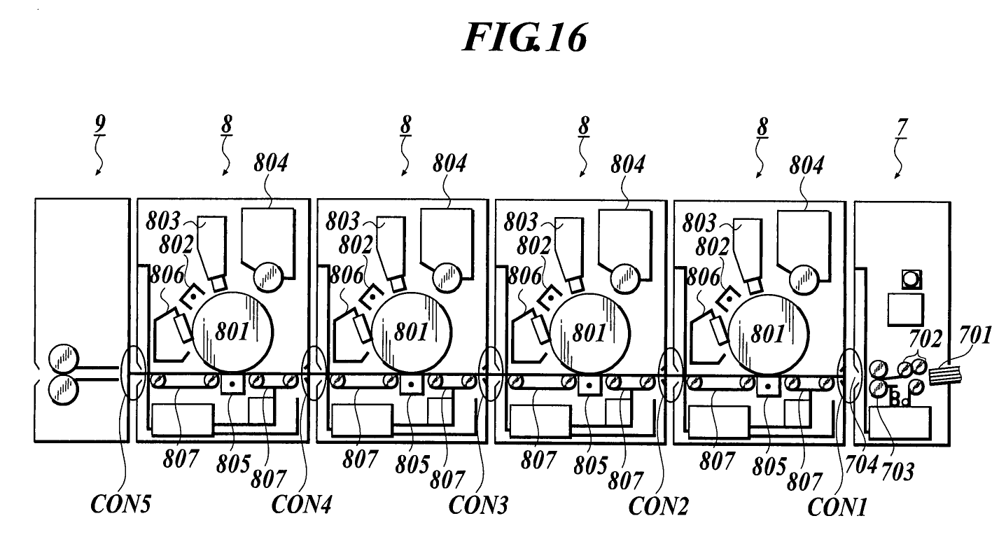

FIG. 16 shows an example of a color image forming apparatus (image forming system) according to the embodiment of the present invention.

The image forming apparatus (image forming system) in the figure for forming a color image comprises a paper feeding unit (paper feeding apparatus) 7, four image forming units (image forming apparatuses) 8, and an image fixing unit (post-processing apparatus) 9.

The paper feeding unit 7 comprises a paper feeding tray 701, a carrying roller 702, and a discharge roller 703. A plurality of papers P are placed on the paper feeding tray 701, and are carried one by one by the carrying roller 702 to be discharged from a paper discharge opening 704.

The four image forming units 8 are for forming a yellow image, a magenta image, a cyan image and a black image, respectively, and each of which is provided with a process section comprising a charging device 802, an exposure device 803, a development device 804, a transfer device 805, and a cleaning device 806 around a drum-like photosensitive body 801.

A toner image is formed on the photosensitive body 801 through the operations of charging by the charging device 802, exposure by the exposure device 803 and developing by the development device 804. The toner image is transferred by the transfer device 805 onto a paper P which was fed from the paper feeding apparatus 7 and carried by a carrying section 807. The paper P on which the toner image was transferred is fed to the image forming unit 8.

The four image forming units 8 are subjected to a timing control by a control section which is not shown to perform an image formation. The paper P is carried through the four image forming units 8 to form a full color image superposed with toner images of yellow, magenta, cyan and black thereon.

The full color image is fixed on the paper P by the image fixing unit 9.

The paper feeding unit 7 and the image forming unit 8 are coupled by a coupling section CON1, and the four image forming units 8 are coupled by coupling sections CON2-CON4. The most downstream image forming unit 8 and the fixing unit 9 are coupled by a coupling section CON5.

The coupling sections CON1-CON5 are arranged as shown in FIGS. 11 to 14, and have a configuration as shown in the figures.

Therefore, a displacement among toner images formed by each image forming units 8 is not generated, enabling to form a color image having high image quality with no color shift.

According to the present invention, in the image forming system constructed by coupling a plurality of paper handling apparatuses, a carrying error or an image shift arisen from the coupling portions can certainly be prevented, thereby a system which can be stably operated to form a high quality image can be realized.

Also, when a user demands a black and white image, not a color image, the user is only needed to purchase one image forming unit (image forming apparatus). When a user demands a color image, the user purchases an image forming unit (image forming apparatuses) for each color needed. Therefore, a user can obtain a desired image forming apparatus (image forming system) at low cost. Moreover, in the color image forming apparatus (image forming system), image forming units (image forming apparatuses) can individually be replaced, thereby the apparatus can be renewed at low cost.

Further, it can realize to perform double-side image formation with high productivity.

The entire disclosure of Japanese Patent Applications No. Tokugan 2003-165068 which was filed on Jun. 10, 2003, including specification, claims, drawings and summary are incorporated herein by reference in its entirety.

What is claimed is:

1. A paper handling apparatus comprising:
at least one of a paper guide opening for receiving a paper carried from outside, and a paper discharge opening for discharging a paper outside; and
a coupling section for coupling to other paper handling at a position approximately equal to that of the paper guide opening or the paper discharge opening in a vertical direction.

2. The paper handling apparatus of claim 1, wherein the coupling section is arranged at two positions approximately symmetric with respect to a center of a carrying path in a paper carrying direction.

3. The paper handling apparatus of claim 1, wherein the coupling section is arranged at a position within a range of ±60 mm from a position of the paper guide opening or the paper discharge opening in a vertical direction.

4. The paper handling apparatus of claim 1, wherein the paper handling apparatus comprises both of the paper guide opening and the paper discharge opening, which are arranged at an approximately same position in a vertical direction.

5. The paper handling apparatus of claim 1, wherein the paper handling apparatus comprises any one of an image forming apparatus for forming an image, a paper feeding apparatus for feeding the paper to the image forming apparatus, and a paper post-processing apparatus for performing a post-process to the paper which was discharged from the image forming apparatus.

6. An image forming system comprising:
a plurality of paper handling apparatuses,
wherein each of the paper handling apparatuses comprises at least one of a paper guide opening for receiving a paper carried from outside, and a paper discharge opening for discharging a paper outside, and a coupling section for coupling to other paper handling apparatus at a position approximately equal to that of the paper guide opening or the paper discharge opening in a vertical direction; and the plurality of paper handling apparatuses are coupled by the coupling section.

7. The image forming system of claim 6, wherein the coupling section is arranged at two positions approximately symmetric with respect a center of a carrying path in a paper carrying.

8. The image forming system of claim 6, wherein the coupling section is arranged at a position within a range of ±60 mm from a position of the paper guide opening or the paper discharge opening in a vertical direction.

9. The image forming system of claim 6, wherein at least one of the plurality of paper handling apparatuses comprises both of the paper guide opening and the paper discharge opening, which are arranged at an approximately same position in a vertical direction.

10. The image forming system of claim 6, wherein each of the plurality of paper handling apparatuses comprises any one of an image forming apparatus for forming an image, a paper feeding apparatus for feeding the paper to the image forming apparatus, and a paper post-processing apparatus for performing a post-process to the paper which was discharged from the image forming apparatus.

11. The image forming system of claim 6, wherein any one of the plurality of paper handling apparatuses comprises an image forming apparatus comprising a displacement detection section for detecting a displacement of a paper in a direction perpendicular to a paper carrying direction, and a correction section for correcting a displacement of the paper according to a detected result by the displacement detection section.

12. The image forming system of claim 6, comprising an image forming apparatus on an upstream side for forming an image on a first side of the paper and, an image forming apparatus on a downstream side for forming an image on a second surface of the paper.
